(19) United States
(12) Patent Application Publication
(10) Pub. No.: US 2018/0137537 A1
(43) Pub. Date: May 17, 2018

(54) SYSTEMS AND METHODS FOR PRESENTING PERSONALIZED MAP LABELS

(71) Applicant: OneMarket Network LLC, San Francisco, CA (US)

(72) Inventor: James Arthur Wilson, San Francisco, CA (US)

(73) Assignee: OneMarket Network LLC, San Francisco, CA (US)

(21) Appl. No.: 15/811,376

(22) Filed: Nov. 13, 2017

Related U.S. Application Data
(60) Provisional application No. 62/421,883, filed on Nov. 14, 2016.

(51) Int. Cl. G06Q 30/02; G06F 17/30

(52) U.S. Cl. CPC G06Q 30/0261; G06T 11/60; G06Q 30/0269; G06F 17/30241

(57) ABSTRACT

Disclosed are systems, methods, and devices for presenting personalized map labels. In one embodiment, the method comprises receiving a request for a map; retrieving a user profile associated with the identification of the user; identifying merchant information within a predefined distance from the location of the user; identifying a correlation between the user profile and the merchant information; ranking the merchant information based on the correlation identified between the user profile and the merchant information; generating one or more labels based on the ranking of the merchant information; and transmitting map data and the one or more labels to the user.

### CLAIM OF PRIORITY

This application claims priority under 35 U.S.C. § 119(e) of U.S. Provisional Patent Application Ser. No. 62/421,883, filed Nov. 14, 2016, entitled “SYSTEM AND METHOD FOR PRESENTING PERSONALIZED MAP LABELS, which is herein incorporated by reference in its entirety.

### COPYRIGHT NOTICE

This application includes material that may be subject to copyright protection. The copyright owner has no objection to the facsimile reproduction by anyone of the patent disclosure as it appears in the Patent and Trademark Office files or records, but otherwise reserves all copyright rights whatsoever.

### BACKGROUND

Prior to the advent of the Internet and mobile computing, navigation was limited to physical, printed maps. As printed matter, these maps were, of course, static and unchanging until updated by a publisher. Due to the static nature of pre-Internet maps, map publishers were forced to generate maps having the widest possible appeal and were limited by the physical nature of maps themselves (e.g., forced to pick and choose what landmarks to place on physical maps). As such, physical maps, while allowing for basic navigation, provided little in the way of “value added” features, such as representing landmarks and other points of interest.

Currently, many digital systems have been developed to provide map-related data to users. Users can now access map-related data on desktop computers, dedicated GPS devices, and most recently, mobile computing devices (e.g., mobile phones, tablets, smart watches, etc.). These devices generally display a traditional map (e.g., a display with cities, roads, etc.) in various formats. For example, mobile devices may present a matrix of map tiles, where each tile represents a portion of the map. Thus, current systems attempt to mimic traditional, printed maps while allowing for a theoretically unlimited level of detail via panning and zooming operations.

While early systems focused primarily on driving directions, and thus primarily provided road-level detail, current systems often provide additional detail. For example, popular web-based and mobile map applications provide both road detail as well as location-based detail such as details regarding businesses, building outlines, and supplemental content from third-party websites (e.g., “reviews” for restaurants).

Notably, however, current systems fail to utilize the wealth of information provided by users in, for example, user profiles. As one example, current systems fail to dynamically adjust the amount and types of labels presented on a map based on a user's interests and/or interests derived from a user profile.

Thus, a need exists in the art to optimize and personalize the display of content displayed in conjunction with digital maps (such as labels on a map). Specifically, a need exists to optimize memory utilization by mapping applications and provide personalized content to users of mapping applications.

### BRIEF SUMMARY

To remedy the aforementioned deficiencies, the disclosure presents systems, methods, and devices for personalizing the display of map content based on user preferences.

In one embodiment, the disclosure describes a method for presenting personalized map labels. In this embodiment, the method comprises receiving a request for a map, where the request includes an identification and location of a user; retrieving a user profile associated with the identification of the user, wherein the user profile includes information regarding the user's preferences for one or more stores, product categories, or products; identifying merchant information within a predefined distance from the location of the user, wherein the merchant information includes information regarding one or more stores, product categories, or products located within the predefined distance; identifying a correlation between the user profile and the merchant information; ranking the merchant information based on the correlation identified between the user profile and the merchant information; generating one or more labels based on the ranking of the merchant information, wherein the one or more labels identify a subset of stores, product categories, or products present within the ranked merchant information; and transmitting map data and the one or more labels to the user.

In one embodiment, the disclosure describes a device for presenting personalized map labels. In this embodiment, the device comprises one or more processors and a non-transitory memory storing computer-executable instructions therein that, when executed by the processors, cause the device to receive a request for a map, where the request includes an identification and location of a user; retrieve a user profile associated with the identification of the user, wherein the user profile includes information regarding the user's preferences for one or more stores, product categories, or products; identify merchant information within a predefined distance from the location of the user, wherein the merchant information includes information regarding one or more stores, product categories, or products located within the predefined distance; identify a correlation between the user profile and the merchant information; rank the merchant information based on the correlation identified between the user profile and the merchant information; generate one or more labels based on the ranking of the merchant information, wherein the one or more labels identify a subset of stores, product categories, or products present within the ranked merchant information; and transmit map data and the one or more labels to the user.

In one embodiment, the disclosure describes a system for presenting personalized map labels. In this embodiment, the system comprises a user profile database configured to store one or more user profiles, wherein a user profile includes information regarding the user's preferences for one or more stores, product categories, or product; a location database configured to store merchant information associated with one or more locations, wherein the merchant information includes information regarding one or more stores, product categories, or products; and a map database configured to store one or more map tiles. The system further includes a location processor configured to receive a request for a map, where the request includes the identification and location of the user; retrieve one or more map tiles from the map database based on the location of the user; generate one or more labels in response to receiving ranked merchant information from a user profile processor, wherein the one or more labels identify a subset of stores, product categories, or products present within the ranked merchant information; and transmit map data and the one or more labels to the user. The system further includes a user profile processor configured to retrieve a user profile associated with the identification of the user, wherein the user profile includes information regarding the user's preferences for one or more stores, product categories, or products; identify merchant information within a predefined distance from the location of the user, wherein the merchant information includes information regarding one or more stores, product categories, or products located within the predefined distance; identifying a correlation between the user profile and the merchant information; ranking the merchant information based on the correlation identified between the user profile and the merchant information; and transmit the ranked merchant information to the location processor.

### BRIEF DESCRIPTION OF THE DRAWINGS

The foregoing and other objects, features, and advantages of the disclosure will be apparent from the following description of embodiments as illustrated in the accompanying drawings, in which reference characters refer to the same parts throughout the various views. The drawings are not necessarily to scale, emphasis instead being placed upon illustrating principles of the disclosure.

FIG. 1 is a flow diagram illustrating a method for presenting personalized map labels according to some embodiments of the disclosure.

FIG. 2 is a flow diagram illustrating a method for generating personalized map labels according to some embodiments of the disclosure.

FIGS. 3A through 3D are screen diagrams, each illustrating a user interface for presenting personalized map labels according to some embodiments of the disclosure.

FIG. 4 is a network diagram illustrating a system for presenting personalized map labels according to some embodiments of the disclosure.

FIG. 5 is a physical diagram illustrating a mobile device for presenting personalized map labels according to some embodiments of the disclosure.

FIG. 6 is a logical block diagram illustrating a server device for presenting personalized map labels according to some embodiments of the disclosure.

### DETAILED DESCRIPTION

The present disclosure will now be described more fully hereinafter with reference to the accompanying drawings, which form a part hereof, and which show, by way of illustration, certain example embodiments.

Systems and methods for overlaying personalized map labels on a map of a location such as a shopping center or mall are disclosed herein. The disclosed embodiments utilize a user profile associated with a user making a request for a map. The user profile stores a variety of historical information regarding the user, such as the user's favorite stores, the user's favorite or preferred product categories, and a history of the products purchased by the user.

In lieu of, or in combination with, simply displaying labels representing store names or identifiers on the map, the embodiments disclosed herein supplement existing labelling techniques by utilizing user profiles to customize a set of labels to present to a user. By doing so, the disclosed embodiments provide highly relevant labels to the user as compared to existing techniques, which simply generate a generic list of labels.

In order to accomplish the foregoing, the embodiments generate a correlation between the user's profile and the locations present within a viewable map area. While often described in terms of locations, the embodiments described herein are equally applicable to location-related data, such as product categories or products themselves.

In order to generate a correlation, the embodiments identify matches between user profiles and location data within a map area. For example, if a map area contains stores that are also tagged as favorites in the user profile, the embodiments rank the names of these stores higher in a list of proposed map labels. Likewise, if the map area contains stores belonging to a user's tagged categories (but the same stores are not tagged by the user), the embodiments can additionally rank these categories and/or stores higher than other stores or categories.

By utilizing a user profile and the correlation processes described herein, the embodiments are able to generate a prioritized and personalized listing of stores, product categories, and/or products that enable the generation of map labels specific to each individual user.

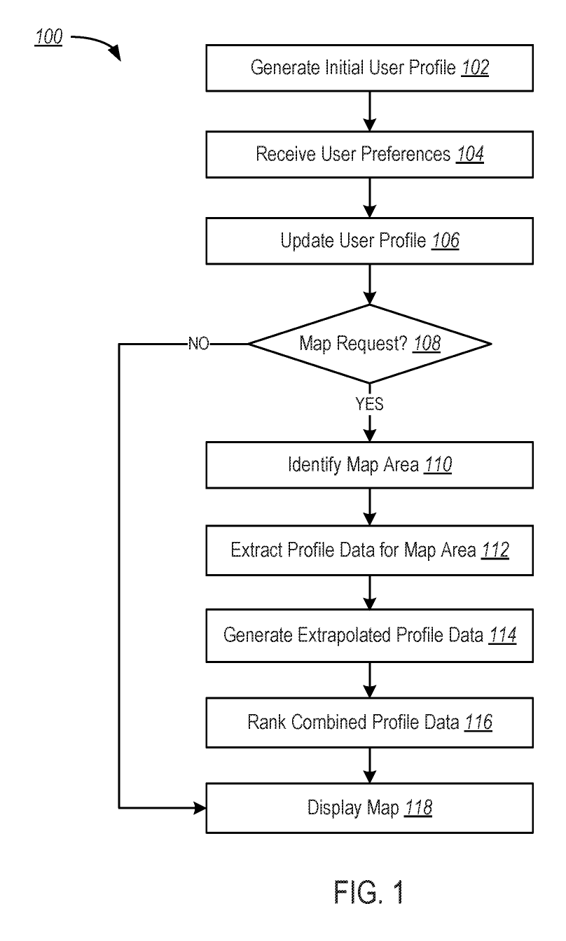

FIG. 1 is a flow diagram illustrating a method for presenting personalized map labels according to some embodiments of the disclosure. In step 102, the method 100 generates an initial user profile. In one embodiment, the initial user profile is generated upon the registration of a user with a website or network-based service. For example, a mobile application or website can allow a user to register an account. During the process, the method 100 can automatically create a “blank” user profile for the user during the registration. Alternatively, the method 100 can present a plurality of questions to the user to generate initial data for the initial user profile. For example, the method 100 can request that upon registration the user identify one or more favorite stores or brands in order to seed an initial user profile with data.

In step 104, the method 100 receives user preferences. In one embodiment, receiving user preferences comprises receiving an indication of user preferences explicitly from the user. For example, a user can add additional favorite stores to a user profile using a web or mobile interface. Likewise, a user can remove stores from a list of favorites or re-order stores within a list of favorite stores. Manual updates to user profiles can likewise adjust other types of data such as brands, locations, store sales, sale types, and other commercial data relevant to identifying a store that may be of interest to a user.

In step 106, the method 100 updates user profile data. In one embodiment, updating user profile data comprises storing the updated user profile data within a database storing user profiles. In one embodiment, the method 100 updates the user profile in response to predefined events such as the detection of activity. In alternative embodiments, the method 100 updates a user profile at predefined intervals. In other embodiments, the method 100 only updates a profile at predefined intervals upon the detection of certain conditions. For example, the method 100 can update a user profile at predefined intervals upon determining that the user is within a predefined geo-fenced zone (e.g., a shopping mall).

In step 108, the method 100 determines if a map request is received. In one embodiment, the method transmits a map request from a mobile application to a server configured to provide map-related data. In some embodiments, the method transmits a map request as an HTTP request or similar request. In one embodiment, the method transmits a map request upon the execution of a mapping application on a client device (e.g., an initial map request). Alternatively, or in conjunction with the foregoing, a map request comprises one or more supplemental map requests issued after an initial map request. For example, upon executing a mapping application, a client device can transmit periodic map requests at a predefined interval or upon detecting that the client device's position has been updated.

In step 110, the method 100 identifies a map area. In one embodiment, a map request includes the geographic coordinates of a user. Alternatively, or in conjunction with the foregoing, the map request includes an altitude or floor level of a user (e.g., if a user is located within a multi-story location). In response, the method 100 extracts the coordinates of the user and identifies a map area associated with the coordinates. In one embodiment, the method 100 utilizes a bounding box to identify a rectilinear area associated with the coordinates. For example, the method 100 can identify a 500-foot by 500-foot area as the identified map area in response to the map request.

In one embodiment, identifying a map area comprises identifying one or more map “tiles” (e.g., images depicting a map). Alternatively, or in conjunction with the foregoing, identifying a map area additionally comprises identifying details regarding locations present within the map area. For example, the method 100 can identify a listing of stores present within the rectilinear map area as well as details regarding the stores, such as store names, products sold, operating hours, etc.

In step 112, the method 100 extracts profile data from a user profile for the identified map area. As discussed previously, in some embodiments, a user profile contains information regarding a user's preferences and prior interactions with one or more stores. For example, a user profile can contain a listing of favorite stores, a listing of favorite product categories, a listing of past purchases, a listing of past stores visited, etc. In step 112, the method 100 extracts relevant profile data from the user profile data based on the identified stores, or other information present within the rectilinear map area.

For example, in step 110 the method 100 identifies a plurality of stores (Stores A, B, and C) and a plurality of store categories (e.g., “sporting goods,” “luxury goods,” etc.). Next, in step 112, the method 100 extracts any information from the user profile relating to Stores A, B, and C or the identified product categories. Additionally, the method 100 extracts a list of products purchased from Stores A, B, or C or a list of products purchased within the identified product categories.

In step 114, the method 100 generates extrapolated profile data. In some embodiments, the method 100 may not identify any relevant profile data corresponding to the map area. For example, a user may not have made any purchases at stores appearing within the map area. In this embodiment, the method 100 attempts to synthesize potential profile data based on the user's overall profile. For example, if a user has previously shopped at Store D and the method 100 determines that Store A is similar to Store D (e.g., sells goods within the same product category), the method 100 will place Store D in the extrapolated profile data. Likewise, the method 100 can determine, based on aggregated analysis, that users who purchase items in one category not appearing within the map area may oftentimes purchase items in a second category appearing in the map area. In this example, the method 100 adds the category appearing within the map area to the extrapolated profile data. For example, a user may have made frequent purchases categorized under “home goods” while the category associated with such stores may not appear within the map area. Based on trends of other users, the method 100 can determine that many users who frequently shop for home goods are also interested in furniture stores. Thus, in this embodiment, the method 100 extrapolates the current user's profile to include furniture stores and includes the category within the user's extrapolated profile data.

In step 116, the method 100 ranks the combined profile data (including user profile data extracted in step 112) and extrapolated data generated in step 114. In one embodiment, ranking profile data comprises determining the relative importance of the profile data to the user. For example, profile data generated in steps 112 and 114 can include a preference for stores A, B, C, and D. In this example, the method 100 determines that a user shops most frequently at store C followed by stores D, B, and A. Thus, the method 100 ranks the profile data in the order in which a user exhibits a preference for each store. In some embodiments, the method 100 additionally performs a similar ranking for product categories or past purchases.

In step 118, the method 100 displays a map including the image data and the ranked profile data. In one embodiment, displaying a map comprises displaying map tiles on a mobile device and overlaying information regarding the map area “on top” of the map tiles. In one embodiment, information regarding the map area includes labels generated based on the profile data determined in steps 112 through 116.

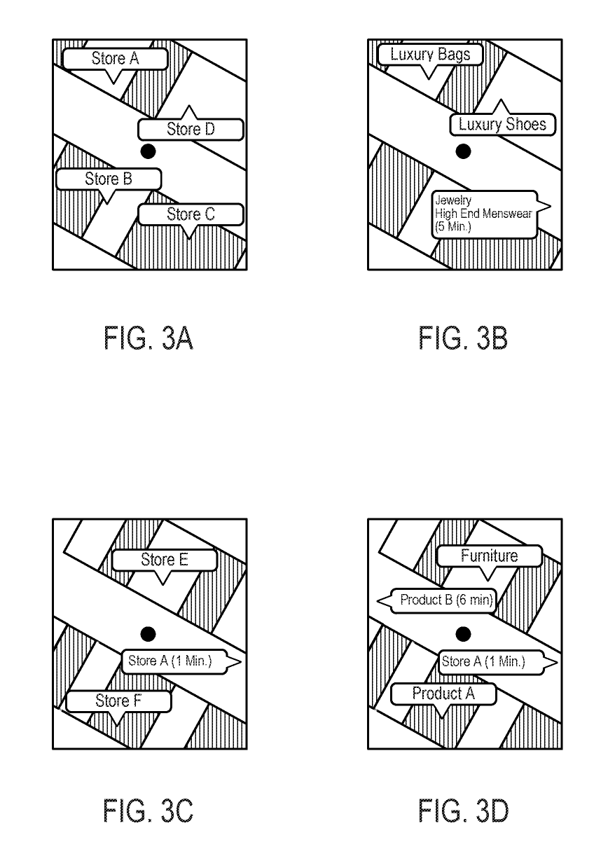

In one embodiment, the method 100 in step 118 selects a subset of the ranked profile data to display on the map. Notably, a map area often contains a limited amount of space in which to display information. Thus, the method 100 utilizes the ranked profile data to select the top N profile data points to display within the map area. Examples of displaying profile data on top of a map area are depicted in FIGS. 3A through 3D and described more fully in connection thereof. Specific techniques for displaying a subset of labels are described more fully in commonly owned application Ser. No. 15/340,666 entitled “System and Method for Presenting Optimized Map Labels,” the contents of which are incorporated herein by reference.

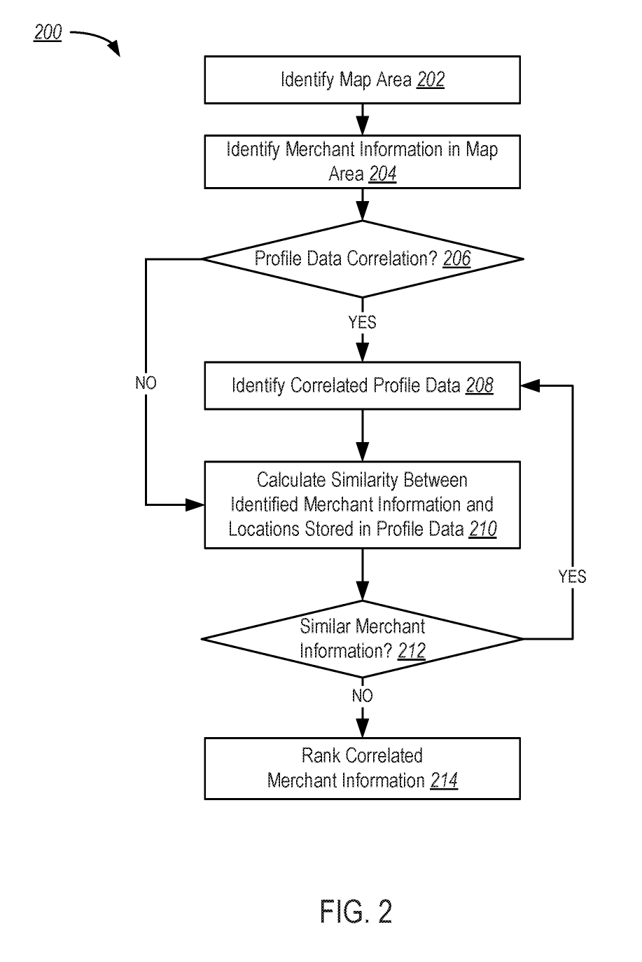

FIG. 2 is a flow diagram illustrating a method for generating personalized map labels according to some embodiments of the disclosure. In step 202, the method 200 identifies a map area. In one embodiment, a map request includes the geographic coordinates of a user. Alternatively, or in conjunction with the foregoing, the map request includes an altitude or floor level of a user (e.g., if a user is located within a multi-story location). In response, the method 200 extracts the coordinates of the user and identifies a map area associated with the coordinates. In one embodiment, the method 200 utilizes a bounding box to identify a rectilinear area associated with the coordinates. For example, the method 200 can identify a 500-foot by 500-foot area centered at the user's coordinates as the identified map area in response to the map request.

In step 204, the method 200 identifies merchant information (e.g., locations) located within the map area. As discussed previously, a map area comprises a rectilinear set of geographic coordinates. In some embodiments, locations are represented in a database wherein each location is associated with one or more geographic coordinates. For example, a location can be associated with a single point or by a set of points defining the outline of the location (e.g., a store). In step 204, the method 200 uses the bounding map area to identify those locations that fall completely or partially within the map area so as to associate one or more locations with the currently requested map area.

In alternative embodiments, the method 200 further associates each location with one or more identifiers of map tiles. In this embodiment, the method 200 identifies one or more tiles associated with the map area and determines a plurality of identifiers associated with the tiles in the map area. The method 200 then queries a location database using the identified identifiers to retrieve a listing of locations.

In alternative embodiments, the method 200 additionally retrieves information other than location information in response to identifying a map area. For example, after identifying one or more locations, the method 200 can further identify a listing of products, product categories, or other information relating to the location based on the identity of the identified stores. In one embodiment, the method 200 stores such information in a separate database or separate database table. In this embodiment, the method 200 uses the identifier of the location to extract this additional information from separate databases or database tables.

In step 206, the method 200 determines if there is any correlation between the profile data and the merchant information identified in the map area. In one embodiment, a correlation between profile data and merchant information identified in the map area comprises a degree of similarity between data points in the profile data and data points in the merchant information retrieved in step 204.

As a non-limiting example, the merchant information returned in step 204 can comprise the following:

TABLE 1

| Store | Categories | Products |
|---|---|---|
| Store A | Sporting Goods, Menswear | Product A, Product B, Product C |
| Store B | Luxury Goods, Shoes, | Product B, Product D, Product E |
| | Menswear | |
| Store C | Furniture | Product F, Product G |
| Store X | Food & Dining | Product X |
| Store Y | Food & Dining | Product Y |
| Store Z | Electronics | Product I, Product J, Product K |

Continuing this example, the method 200 can retrieve a user profile that includes the following data:

TABLE 2

| Favorite Stores | Favorite Categories | Products |
|---|---|---|
| Store B | Sporting Goods | Product H |
| Store D | Home Improvement | Product A |
| Store E | Home Goods | Product B |

In this example, the method 200 (in step 206) first identifies correlated stores comprising Store B. That is, the method 200 compares stores that were “favorited” by a user (e.g., Stores B, D, and E) to a listing of stores within a map area (e.g., Stores A, B, C, X, Y, and Z). Next, the method 200 identifies correlated product categories, “Sporting Goods” (i.e., overlapping categories in both a user profile in Table 2 and merchant information in Table 1). Finally, the method 200 identifies correlated products comprising Products A and B (i.e., overlapping products in both a user profile in Table 2 and merchant information in Table 1).

In step 208, after determining that there is a correlation between the user profile data and the location data, the method 200 identifies the correlated profile data. In one embodiment, identifying correlated profile data comprises updating the merchant information based on the user profile data, or replacing the merchant information based on the user profile data.

For example, as indicated in the preceding example, there is a correlation between various points in the user profile data and the merchant information (e.g., Store B, the “Sporting Goods” category, and Products A and B). Based on this correlation the method 200 generates the following correlated data set:

TABLE 3

| Stores | Store B |
|---|---|
| Categories | Sporting Goods |
| Products | Product A, Product B |

As illustrated above, the correlated data set corresponds to a subset of the overall merchant information and effectively filters the raw merchant information based on a correlation between the user profile data and the location data. Thus, the method 200 reduces the amount of information presented to a user while simultaneously selecting the most relevant data. In some embodiments, the method 200 utilizes this correlated data set to generate one or more labels to overlay on a map area of a device. In alternative embodiments, the method 200 further attempts to extrapolate additional data points in the correlated data set if either there is no direct correlation, or if additional data points are desired, as discussed more fully with respect to steps 210 and 212.

In step 210, the method 200 calculates a similarity between the identified merchant information and locations stored in the user profile data. In one embodiment, the method 200 additionally identifies a similarity between products or product categories in the merchant information and the user profile data. In one embodiment, calculating a similarity for merchant information and profile data comprises determining if any stores in the merchant information belong to the same category as favorited stores within user profile data. Alternatively, or in conjunction with the foregoing, the method 200 determines a similarity based on a clustering of related categories.

In alternative embodiments, the method 200 determines a similarity between product categories by utilizing a category hierarchy, wherein two categories are similar if they share a parent category. In another alternative, the method 200 determines a similarity between products by selecting a product identified within the map area and identifying similar purchases from other users. In this embodiment, the method 200 identifies a set of similar products based on the purchase trends of other users and determines if the user profile contains any matching products.

Continuing the previous example, the method 200 can determine that stores in the categories of “Furniture” and “Home Goods” are similar. If so, the method 200 adds “Store C” in Table 1 to the correlated data set (as illustrated in Table 3) under the assumption that since the user associated with Table 2 is interested in Home Goods, the user will also be interested in Store C (a furniture store). Alternatively, or in conjunction with the foregoing, the method 200 also adds the category “Furniture” to the correlated data set.

Thus, the method 200 updates the correlated data set in Table 3 as follows:

TABLE 4

| Stores | Store C, Store B |
|---|---|
| Categories | Furniture, Sporting Goods |
| Products | Product A, Product B |

Additionally, in some embodiments, the method 200 determines a similarity between products a user has favorited or purchased and those offered by stores within the map area. Continuing the previous example, the user represented in Table 2 has favorited or purchased Product B, albeit from Store E, which does not appear in the merchant information represented in Table 1. In this embodiment, the method 200 determines that a user may be interested in Store B since Store A additionally sells Product B. Thus, the method 200 updates the correlated data set (illustrated in Table 4) as follows:

TABLE 5

| Stores | Store A, Store C, Store B |
|---|---|
| Categories | Furniture, Sporting Goods |
| Products | Product A, Product B |

Thus, as illustrated above, the method 200 through steps 206, 208, and 210 generates a personalized listing of locations present within a map area. Further, as illustrated in Table 5 compared to Table 1, the method 200 filters out locations (Stores X, Y, and Z), product categories (e.g., “Food & Dining”) and products (e.g., Products X, Y, and I) from the original set of merchant information associated with the locations within the map area to generate a personalized merchant information set.

In step 212, the method 200 determines if any similar merchant information (e.g., stores, categories and products) are identified. As illustrated above, the method 200 continues to execute steps 208 and 210 for each similar location, product, or category.

In step 214, after generating a correlated merchant information set, the method 200 ranks the correlated merchant information based on the relative importance of each item. In one embodiment, the method 200 flattens the correlated merchant information into a list of profile data points to be displayed on a map.

For example, the method 200 can rank “Store B”, “Sporting Goods” and Products A and B as higher ranked than the remaining data points due to the fact that these points were explicitly correlated with actual user profile data. Thus, in one embodiment, the method 200 initially generates the following ranked list:

TABLE 6

| | |
|---|---|
| 1 | Store B |
| 2 | Sporting Goods |
| 3 | Product A |
| 4 | Product B |
| 5 | Store C |
| 6 | Store A |
| 7 | Furniture |

Next, the method 200 applies various other ranking rules to rank the remaining items relative to the initial ranking. For example, the method 200 ranks “Store C” higher since Store C represents a location and Store C was correlated based on similar product categories. Likewise, the method 200 ranks the category “Furniture” higher than the identified products in the user profile data since categories of products may be of stronger interest than specific products. Thus, in one embodiment, the method 200 re-ranks the listing of data points as follows:

TABLE 7

| | |
|---|---|
| 1 | Store B |
| 2 | Store C |
| 3 | Sporting Goods |
| 4 | Furniture |
| 5 | Product A |
| 6 | Product B |
| 7 | Store A |

Alternatively, or in conjunction with the foregoing, the method 200 utilizes incentives associated with stores in re-ranking the initial ranking of data points. For example, the method 200 can rank a certain store higher due to promotions organized between the store and the map provider. Similarly, the method 200 can re-rank the initial data based on incentives to the user. For example, the method 200 can re-rank the initial data due to temporal conditions such as sales at certain stores, known relationships (e.g., credit cards) of users at certain stores, or various other considerations.

While illustrated solely in connection with a map area, the method 200 can additionally be executed for locations outside of the map area and may be executed prior to receiving a map request. In this embodiment, the method 200 ranks all locations within a predefined area (e.g., a shopping center).

Alternatively, or in conjunction with the foregoing, the method 200 employs additional data sets when correlating a user profile or ranking a correlated data set. For example, the method 200 can utilize a “wish list” or similar data structure to identify products, categories, or stores of interest and may rank such items higher than other items. In this manner, the method 200 intelligently directs a user's shopping experience without further user input from the user (e.g., searching for which stores sell products on a wish list).

FIGS. 3A through 3D are screen diagrams, each illustrating a user interface for presenting personalized map labels according to some embodiments of the disclosure. FIG. 3A illustrates a listing of map labels based on the location of a user within a shopping center according to some embodiments of the disclosure. Specifically, FIG. 3A illustrates a user interface wherein a plurality of labels (for Stores A, B, C, and D) are selected and presented to a user. Notably, in FIG. 3A the user interface only displays a subset of the total number of stores (e.g., omitting the store between Stores A and D and the store between Stores B and C). As discussed previously in connection with FIGS. 1 and 2, the user interface in FIG. 3A is generated based on analyzing a user's profile and determining that Stores A, B, C, and D are of the strongest interest to a user.

FIG. 3B illustrates a listing of map labels based on the location of a user within a shopping center according to some embodiments of the disclosure. Specifically, FIG. 3B illustrates an alternative embodiment, wherein the user interface displays product categories instead of store names or identifiers. In this embodiment, using the methods described in connection with FIGS. 1 and 2, the user interface provides personalized product category recommendations to a user while the user is viewing a map of a shopping center.

FIG. 3B additionally illustrates a directional label (“Jewelry, High End Menswear (5 Min.)”) that directs a user to a location of interest based on the correlated data set. As illustrated in FIG. 3B, the user interface omits labels for Stores B and C based on the determination that the categories “Luxury Shoes,” “Jewelry,” and “High End Menswear” are of higher interest to the user than Stores B and C (as discussed more fully in connection with FIG. 2). Additionally, the user interface presents off-map indicators based on the strength of the user's interest in “Jewelry” and “High End Menswear” as compared to Stores B and C.

FIG. 3C illustrates a listing of map labels after receiving a “pan” operation in response to viewing the user interface depicted in FIG. 3A or 3B according to some embodiments of the disclosure. As illustrated in FIG. 3C, the user interface illustrates a directional label for Store A and new labels for Stores E and F. As discussed in connection with FIGS. 1 and 2, the user interface in FIG. 3C is generated based on determining that Store A is of the higher interest to the user than the locations, categories, or products present within the map area depicted in FIG. 3C. Likewise, Stores E and F are presented because the stores are higher ranked than the remaining categories or products within the map area depicted in FIG. 3C. In some embodiments, the user interface illustrated in FIG. 3C generates a response to a change detected in the location of the user, as discussed in connection with FIG. 1.

FIG. 3D illustrates a listing of map labels after receiving a “pan” operation in response to viewing the user interface depicted in FIG. 3A or 3B according to some embodiments of the disclosure. As illustrated in FIG. 3D, a user interface includes a combination of store labels (e.g., “Store A”), product category labels (e.g., “Furniture”), and products (e.g., Products A and B). As illustrated in FIG. 3D, the relative importance of each label determines which user interface is to be presented. For example, instead of using a label for “Store F” as in FIG. 3C, the user interface in FIG. 3D uses “Product A” since Product A is higher ranked than Store F and is more suitable for garnering a user's interest. Likewise, in FIG. 3C, “Store E” was selected based on a correlation between other stores and Store E. However, the user may not be aware of what “Store E” sells. Thus, the user interface in FIG. 3D replaces “Store E” with a category name (“Furniture”) based on the ranking of the category in the correlated data set and the fact that Store E was not explicitly identified in the user profile data.

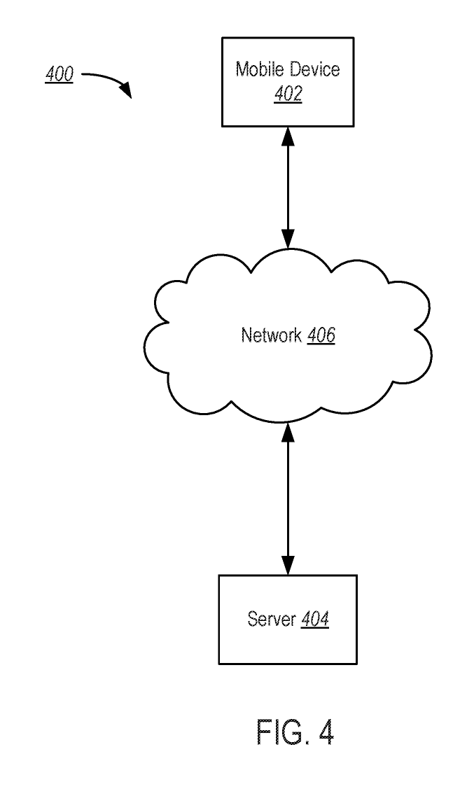

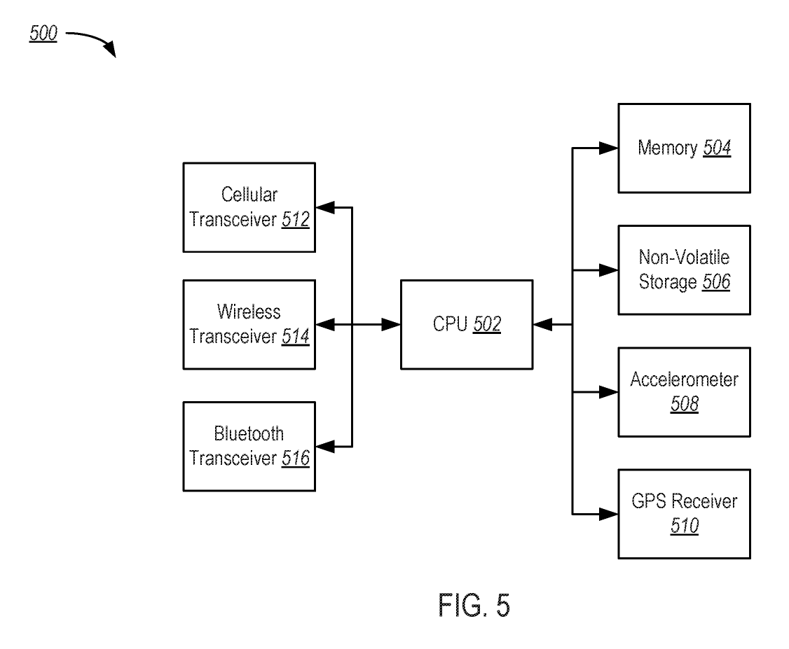

FIG. 4 is a network diagram illustrating a system for presenting map labels according to some embodiments of the disclosure. As illustrated in FIG. 4, the system 400 includes a mobile device 402, a server 404, and a network 406. As illustrated in FIG. 4, the mobile device 402 comprises a computing device designed to be carried by a user. In one embodiment, the mobile device 402 includes a device such as the one illustrated in FIG. 5. The mobile device 402 collects data generated by various hardware components present within the mobile device 402, such as GPS receivers, accelerometers, gyroscopes, or other devices capable of recording data regarding the movement or activity of the mobile device 402. Additionally, mobile device 402 displays map data (e.g., map tiles) in response to a user's request to view a map. In addition to geographic detail, the mobile device 402 displays labels and other information as an “overlay” of the map data.

As discussed in more detail herein, the mobile device 402 can further include processing logic (e.g., a CPU, system-on-a-chip, GPU, etc.) that receives and processes movement or location data from other components (e.g., GPS receivers, accelerometers, gyroscopes, etc.). In some embodiments, the mobile device 402 receives data and pre-process data prior to transmittal. In addition to recording and processing data, the mobile device 402 transmits data, including location and event data, to other devices via the network 406.

Although illustrated as a single network, the network 406 can comprise multiple networks facilitating communication between devices. In one embodiment, the network 406 includes a wireless fidelity (“Wi-Fi”) network as defined by the IEEE 802.11 standards or equivalent standards. In this embodiment, the network 406 enables the transfer of location or event data from the mobile device 402 to the server 404. In an alternative embodiment, the network 406 comprises a mobile network such as a cellular network. In this embodiment, data can be transferred between the illustrated devices in a manner similar to the embodiment wherein the network 406 is a Wi-Fi network. While described in isolation, the network 406 can include multiple networks.

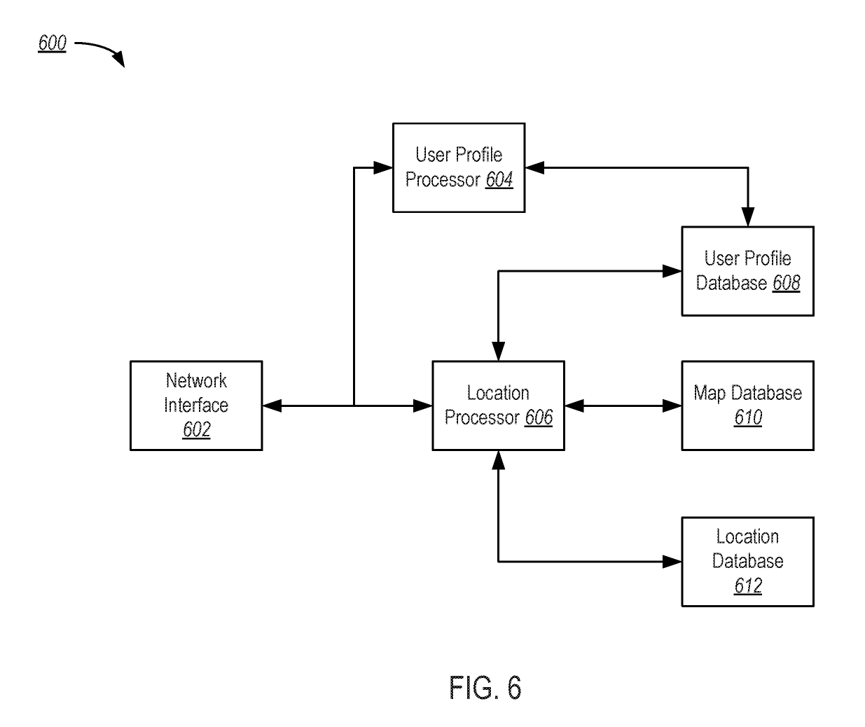

As discussed in more detail with respect to FIG. 6, the server 404 receives requests from the mobile device 402 and provides responses to such requests. In one embodiment, the server 404 receives requests for map data from the mobile device 402 and provides map data in response. Alternatively, or in conjunction with the foregoing, the server 404 receives and stores user profile information in one or more databases. Alternatively, or in conjunction with the foregoing, the server 404 updates user profile data based on activity data received from the mobile device 402 or third party sources (not illustrated). Alternatively, or in conjunction with the foregoing, the server 404 provides location details to the mobile device 402.

FIG. 5 is a physical diagram illustrating a mobile device 500 for presenting map labels according to some embodiments of the disclosure. The device 500 includes a CPU 502, a memory 504, a non-volatile storage 506, an accelerometer 508, a GPS receiver 510, a cellular transceiver 512, a wireless transceiver 514, and a Bluetooth transceiver 516.

The device 500 includes the accelerometer 508 and the GPS receiver 510, which monitor the device 500 to identify its position (via the GPS receiver 510) and its acceleration (via the accelerometer 508). Although illustrated as a single component, the accelerometer 508 and the GPS receiver 510 can alternatively each include multiple components providing similar functionality. Alternatively, or in conjunction with the foregoing, the device 500 includes the Bluetooth transceiver 516 that tracks the position of a device using, for example, low-energy Bluetooth beacons (e.g., using protocols such as the iBeacon protocol or similar protocols).

The Accelerometer 508 and the GPS receiver 510 generate data as described in more detail herein and transmit the data to other components via the CPU 502. Alternatively, or in conjunction with the foregoing, the accelerometer 508 and the GPS receiver 510 transmit data to the memory 504 for short-term storage.

In one embodiment, the memory 504 comprises a random access memory device or similar volatile storage device. In this embodiment, the CPU 502 accesses the data (e.g., location and/or event data) from the memory 504. Alternatively, or in conjunction with the foregoing, the accelerometer 508 and the GPS receiver 510 transmit data directly to the non-volatile storage 506. Alternatively, or in conjunction with the foregoing, the CPU 502 receives data (e.g., position data received using a beacon protocol) from a the Bluetooth transceiver 516. In some embodiments, the non-volatile storage 506 comprises a solid-state storage device (e.g., a “flash” storage device) or a traditional storage device (e.g., a hard disk). Specifically, the GPS receiver 510 transmits location data (e.g., latitude, longitude, etc.) to the CPU 502, the memory 504, or the non-volatile storage 506 in similar manners. In some embodiments, the CPU 502 comprises a field-programmable gate array or a customized, application-specific integrated circuit.

In the illustrated embodiment, the memory 504 stores one or more applications such as a mapping application. In this embodiment, applications stored in the memory 504 perform the methods described in more detail in connection with FIG. 5.

As illustrated in FIG. 5, the device 500 includes multiple network interfaces including the cellular transceiver 512, the wireless transceiver 514, and the Bluetooth transceiver 516. As discussed in connection with FIG. 3, the cellular transceiver 512 enables the device 500 to transmit event or location data, processed by the CPU 502, to a server via a mobile or radio network. Additionally, the CPU 502 determines the format and contents of data transferred using the cellular transceiver 512, the wireless transceiver 514, and the Bluetooth transceiver 516.

FIG. 6 is a logical block diagram illustrating a server device for presenting map labels according to some embodiments of the disclosure. As illustrated in FIG. 6, a device 600 includes a network interface 602, a user profile processor 604, a location processor 606, a user profile database 608, a map database 610, and a location database 612. Although illustrated as a single device, each of the components of device 600 can be located remotely from one another (that is, each component can reside on a separate server).

The device 600 includes the user profile processor 604. In one embodiment, the user profile processor 604 receives profile data from users via the network interface 602. In one embodiment, the user profile processor 604 performs the methods described in connection with FIG. 2, the description of which is incorporated by reference in its entirety. Specifically, the user profile processor 604 generates a correlated merchant information data set described in connection with FIG. 2.

The user profile processor 604 additionally stores user profile data in the user profile database 608. In one embodiment, the user profile processor 604 comprises one or more server devices distributed in multiple locations or within a single location. In one embodiment, the user profile database 608 comprises one or more relational databases or non-relational databases distributed in multiple locations or within a single location.

As discussed more fully in connection with FIGS. 1 and 2, the user profile processor 604 receives user profile data (such as preferences, favorite stores, etc.) from a user and stores those preferences within a user account stored in the user profile database 608. Additionally, the user profile processor 604 receives location data from the location processor 606 (and the location database 612) and generates a correlated merchant information set based on the received location data. Additionally, the user profile processor 604 receives browsing history data, deal or offer data (e.g., conversion of offers or deals transmitted to a user), event or sale data (e.g., events or sales attended by the user), transaction data, product interaction data, or location information from users via the network interface 602.

The device 600 includes the location processor 606. In one embodiment, the location processor 606 receives requests from users via the network interface 602. In one embodiment, the location processor 606 performs the method described in connection with FIG. 1, the description of which is incorporated by reference in its entirety. In one embodiment, requests received by the location processor 606 include requests for map data and location data.

In response to a request for map data, the location processor 606 extracts a geographic area from the request and retrieves one or more map tiles from the map database 610. In one embodiment, the map database 610 comprises one or more relational databases or non-relational databases distributed in multiple locations or within a single location. Alternatively, or in conjunction with the foregoing, the map database 610 includes file storage for storing images representing map tiles. The location processor 606 additionally transmits the map tiles to a user via the network interface 602.

In response to a request for location data, the location processor 606 retrieves a list of locations from the location database 612. In one embodiment, the location database 612 comprises one or more relational databases or non-relational databases distributed in multiple locations or within a single location. For example, the location database 612 can store a relational model of all locations associated with one or more shopping centers including data such as the location name, address, products sold, product categories, sales, deal or offer data, attendance at special or regular events, and other data relating to the location. The location processor 606 additionally transmits location data to a user via the network interface 602.

The subject matter described above may be embodied in a variety of different forms and, therefore, the application/description intends for covered or claimed subject matter to be construed as not being limited to any example embodiments set forth herein; example embodiments are provided merely to be illustrative. Likewise, the application/description intends a reasonably broad scope for claimed or covered subject matter. Among other things, for example, subject matter may be embodied as methods, devices, components, or systems. Accordingly, embodiments may, for example, take the form of hardware, software, firmware or any combination thereof (other than software per se). The description presented above is, therefore, not intended to be taken in a limiting sense.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. The application/description intends, for example, that claimed subject matter includes combinations of example embodiments in whole or in part.

In general, terminology may be understood at least in part from usage in context. For example, terms, such as “and”. “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again may be understood to convey a singular usage or to convey a plural usage, depending at least in part upon context. In addition, the term “based on” may be understood as not necessarily intended to convey an exclusive set of factors and may, instead, allow for the existence of additional factors not necessarily expressly described, again, depending at least in part on context.

The present disclosure is described below with reference to block diagrams and operational illustrations of methods and devices. It is understood that each block of the block diagrams or operational illustrations, and combinations of blocks in the block diagrams or operational illustrations, can be implemented by means of analog or digital hardware and computer program instructions. These computer program instructions can be provided to a processor of a general purpose computer to alter its function as detailed herein, a special purpose computer, ASIC, or other programmable data processing apparatus, such that the instructions, which execute via the processor of the computer or other programmable data processing apparatus, implement the functions/acts specified in the block diagrams or operational block or blocks. In some alternate implementations, the functions/acts noted in the blocks can occur out of the order noted in the operational illustrations. For example, two blocks shown in succession can in fact be executed substantially concurrently or the blocks can sometimes be executed in the reverse order, depending upon the functionality/acts involved.

These computer program instructions can be provided to a processor of: a general purpose computer to alter its function to a special purpose; a special purpose computer; ASIC; or other programmable digital data processing apparatus, such that the instructions, which execute via the processor of the computer or other programmable data processing apparatus, implement the functions/acts specified in the block diagrams or operational block or blocks, thereby transforming their functionality in accordance with embodiments herein.

For the purposes of this disclosure, a computer-readable medium (or computer-readable storage medium/media) stores computer data, which data can include computer program code (or computer-executable instructions) that is executable by a computer, in machine-readable form. By way of example and not limitation, a computer-readable medium may comprise computer-readable storage media, for tangible or fixed storage of data, or communication media for transient interpretation of code-containing signals. Computer-readable storage media, as used herein, refers to physical or tangible storage (as opposed to signals) and includes without limitation volatile and non-volatile, removable and non-removable media implemented in any method or technology for the tangible storage of information such as computer-readable instructions, data structures, program modules or other data. Computer-readable storage media includes, but is not limited to, RAM; ROM; EPROM; EEPROM; flash memory or other solid state memory technology; CD-ROM, DVD, or other optical storage; magnetic cassettes; magnetic tape; magnetic disk storage or other magnetic storage devices; or any other physical or material medium that can be used to tangibly store the desired information or data or instructions and that can be accessed by a computer or processor.

For the purposes of this disclosure the term “server” should be understood to refer to a service point which provides processing, database, and communication facilities. By way of example, and not limitation, the term “server” can refer to a single, physical processor with associated communications and data storage and database facilities, or it can refer to a networked or clustered complex of processors and associated network and storage devices, as well as operating software and one or more database systems and application software that support the services provided by the server. Servers may vary widely in configuration or capabilities, but generally a server may include one or more central processing units and memory. A server may also include one or more mass storage devices, one or more power supplies, one or more wired or wireless network interfaces, one or more input/output interfaces, or one or more operating systems, such as Windows Server, Mac OS X, Unix, Linux, FreeBSD, or the like.

For the purposes of this disclosure a “network” should be understood to refer to a network that may couple devices so that communications may be exchanged, such as between a server and a client device or other types of devices, including between wireless devices coupled via a wireless network, for example. A network may also include mass storage, such as network attached storage (NAS), a storage area network (SAN), or other forms of computer- or machine-readable media, for example. A network may include the Internet, one or more local area networks (LANs), one or more wide area networks (WANs), wire-line type connections, wireless type connections, cellular or any combination thereof. Likewise, sub-networks, which may employ differing architectures or may be compliant or compatible with differing protocols, may interoperate within a larger network. Various types of devices may, for example, be made available to provide an interoperable capability for differing architectures or protocols. As one illustrative example, a router may provide a link between otherwise separate and independent LANs.

A communication link or channel may include, for example, analog telephone lines such as a twisted wire pair; a coaxial cable; full or fractional digital lines including T1, T2, T3, or T4 type lines; Integrated Services Digital Networks (ISDNs); Digital Subscriber Lines (DSLs); wireless links including satellite links; or other communication links or channels, such as may be known to those skilled in the art. Furthermore, a computing device or other related electronic devices may be remotely coupled to a network, such as via a wired or wireless line or link, for example.

For purposes of this disclosure, a “wireless network” should be understood to couple client devices with a network. A wireless network may employ stand-alone, ad-hoc networks, mesh networks, Wireless LAN (WLAN) networks, cellular networks, or the like. A wireless network may further include a system of terminals, gateways, routers, or the like coupled by wireless radio links, or the like, which may move freely, randomly or organize themselves arbitrarily, such that network topology may change, at times even rapidly.

A wireless network may further employ a plurality of network access technologies, including Wi-Fi; Long Term Evolution (LTE); WLAN; Wireless Router (WR) mesh; 2nd, 3rd, or 4th generation (2G, 3G, or 4G) cellular technology; or the like. Network access technologies may enable wide area coverage for devices, such as client devices with varying degrees of mobility, for example.

For example, a network may enable RF or wireless type communication via one or more network access technologies, such as Global System for Mobile communication (GSM), Universal Mobile Telecommunications System (UMTS), General Packet Radio Services (GPRS), Enhanced Data GSM Environment (EDGE), 3GPP Long Term Evolution (LTE), LTE Advanced, Wideband Code Division Multiple Access (WCDMA), Bluetooth, 802.11b/g/n, or the like. A wireless network may include virtually any type of wireless communication mechanism by which signals may be communicated between devices, such as a client device or a computing device, between or within a network, or the like.

A computing device may be capable of sending or receiving signals, such as via a wired or wireless network, or may be capable of processing or storing signals, such as in memory as physical memory states, and may, therefore, operate as a server. Thus, devices capable of operating as a server may include, as examples, dedicated rack-mounted servers; desktop computers; laptop computers; set top boxes; integrated devices combining various features, such as two or more features of the foregoing devices; or the like. Servers may vary widely in configuration or capabilities, but generally a server may include one or more central processing units and memory. A server may also include one or more mass storage devices, one or more power supplies, one or more wired or wireless network interfaces, one or more input/output interfaces, or one or more operating systems, such as Windows Server, Mac OS X, Unix, Linux, FreeBSD, or the like.

For the purposes of this disclosure, a module is a software, hardware, or firmware (or combinations thereof) system; process or functionality; or component thereof, that performs or facilitates the processes, features, and/or functions described herein (with or without human interaction or augmentation). A module can include sub-modules. Software components of a module may be stored on a computer-readable medium for execution by a processor. Modules may be integral to one or more servers, or be loaded and executed by one or more servers. One or more modules may be grouped into an engine or an application.

For the purposes of this disclosure the term “user”, “subscriber”, “consumer” or “customer” should be understood to refer to a user of an application or applications as described herein and/or a consumer of data supplied by a data provider. By way of example, and not limitation, the term “user” or “subscriber” can refer to a person who receives data provided by the data or service provider over the Internet in a browser session, or can refer to an automated software application that receives the data and stores or processes the data.

Those skilled in the art will recognize that the methods and systems of the present disclosure may be implemented in many manners, and as such, are not to be limited by the foregoing exemplary embodiments and examples. In other words, functional elements being performed by single or multiple components, in various combinations of hardware and software or firmware, and individual functions, may be distributed among software applications at either the client level or server level or both. In this regard, any number of the features of the different embodiments described herein may be combined into single or multiple embodiments, and alternate embodiments having fewer than, or more than, all of the features described herein are possible.

Functionality may also be, in whole or in part, distributed among multiple components, in manners now known or to become known. Thus, myriad software/hardware/firmware combinations are possible in achieving the functions, features, interfaces and preferences described herein. Moreover, the scope of the present disclosure covers conventionally known manners for carrying out the described features and functions and interfaces, as well as those variations and modifications that may be made to the hardware or software or firmware components described herein as would be understood by those skilled in the art now and hereafter.

Furthermore, the embodiments of methods presented and described as flowcharts in this disclosure are provided by way of example in order to provide a more complete understanding of the technology. The disclosed methods are not limited to the operations and logical flow presented herein. Alternative embodiments are contemplated in which the order of the various operations is altered and in which sub-operations described as being part of a larger operation are performed independently.

While various embodiments have been described for purposes of this disclosure, such embodiments should not be deemed to limit the teaching of this disclosure to those embodiments. Various changes and modifications may be made to the elements and operations described above to obtain a result that remains within the scope of the systems and processes described in this disclosure.

What is claimed is:

1. A method comprising:
receiving a request for a map, the request including an identification of a user and a location of the user;
retrieving a user profile associated with the identification of the user, wherein the user profile includes information regarding the user's preferences for one or more stores, product categories, or products;
identifying merchant information within a predefined distance from the location of the user, wherein the merchant information includes information regarding one or more stores, product categories, or products located within the predefined distance;
identifying a correlation between the user profile and the merchant information;
ranking the merchant information based on the correlation identified between the user profile and the merchant information;
generating one or more labels based on the ranking of the merchant information, wherein the one or more labels identify a subset of stores, product categories, or products present within the ranked merchant information; and
transmitting map data and the one or more labels to the user.

2. The method of claim 1 wherein the request for a map comprises a network request issued from a mobile device operated by the user.

3. The method of claim 1 wherein identifying a correlation between the user profile and the merchant information comprises identifying one or more stores, product categories, or products that are present within the user profile and the merchant information.

4. The method of claim 1 wherein identifying a correlation between the user profile and the merchant information comprises determining a degree of similarity between one or more stores, product categories, or products present within the user profile and one or more stores, product categories, or products present within the merchant information.

5. The method of claim 4 wherein a determining degree of similarity between a store stored in the user profile and a store stored in the merchant profile comprises determining whether a store stored in the user profile belongs to a same product category as a store in the merchant information.

6. The method of claim 4 wherein a determining degree of similarity between a product category stored in the user profile and a product category stored in the merchant information comprises determining whether the product category stored in the user profile and the product category stored in the merchant information belong to a same parent product category.

7. The method of claim 4 wherein a determining degree of similarity between a product stored in the user profile and a product stored in the merchant information comprises determining whether other users who purchased the product stored in the merchant information have also purchased a product stored in the user profile.

8. The method of claim 1 wherein ranking the merchant information based on the correlation identified between the user profile and the merchant information further comprises identifying one or more events occurring within a predefined area and ranking stores, product categories, or products associated with the one or more events above other stores, product categories, or products present in the merchant information.

9. A device comprising:
one or more processors;
a non-transitory memory storing computer-executable instructions therein that, when executed by the processor, cause the device to:
receive a request for a map, the request including an identification of a user and a location of the user;
retrieve a user profile associated with the identification of the user, wherein the user profile includes information regarding the user's preferences for one or more stores, product categories, or products;
identify merchant information within a predefined distance from the location of the user, wherein the merchant information includes information regarding one or more stores, product categories, or products located within the predefined distance;
identify a correlation between the user profile and the merchant information;
rank the merchant information based on the correlation identified between the user profile and the merchant information;
generate one or more labels based on the ranking of the merchant information, wherein the one or more labels identify a subset of stores, product categories, or products present within the ranked merchant information; and
transmit map data and the one or more labels to the user.

10. The device of claim 9 wherein identifying a correlation between the user profile and the merchant information comprises determining a degree of similarity between one or more stores, product categories, or products present within the user profile and one or more stores, product categories, or products present within the merchant information.

11. The device of claim 10 wherein a determining degree of similarity between a store stored in the user profile and a store stored in the merchant profile comprises determining whether a store stored in the user profile belongs to a same product category as a store in the merchant information.

12. The device of claim 10 wherein a determining degree of similarity between a product category stored in the user profile and a product category stored in the merchant information comprises determining whether the product category stored in the user profile and the product category stored in the merchant information belong to a same parent product category.

13. The device of claim 10 wherein a determining degree of similarity between a product stored in the user profile and a product stored in the merchant information comprises determining whether other users who purchased the product stored in the merchant information have also purchased a product stored in the user profile.

14. A system comprising:
a user profile database configured to store one or more user profiles, wherein a user profile includes information regarding the user's preferences for one or more stores, product categories, or products;
a location database configured to store merchant information associated with one or more locations, wherein the merchant information includes information regarding one or more stores, product categories, or products;
a map database configured to store one or more map tiles;
a location processor configured to:
receive a request for a map, the request including an identification of a user and a location of the user;
retrieve one or more map tiles from the map database based on the location of the user;
generate one or more labels in response to receiving ranked merchant information from a user profile processor, wherein the one or more labels identify a subset of stores, product categories, or products present within the ranked merchant information; and
transmit map data and the one or more labels to the user;
a user profile processor configured to:
retrieve a user profile associated with the identification of the user, wherein the user profile includes information regarding the user's preferences for one or more stores, product categories, or products;
identify merchant information within a predefined distance from the location of the user, wherein the merchant information includes information regarding one or more stores, product categories, or products located within the predefined distance;
identifying a correlation between the user profile and the merchant information;
ranking the merchant information based on the correlation identified between the user profile and the merchant information; and
transmit the ranked merchant information to the location processor.

15. The system of claim 14 wherein identifying a correlation between the user profile and the merchant information comprises identifying one or more stores, product categories, or products that are present within the user profile and the merchant information.

16. The system of claim 14 wherein identifying a correlation between the user profile and the merchant information comprises determining a degree of similarity between one or more stores, product categories, or products present within the user profile and one or more stores, product categories, or products present within the merchant information.

17. The system of claim 16 wherein a determining degree of similarity between a store stored in the user profile and a store stored in the merchant profile comprises determining whether a store stored in the user profile belongs to a same product category as a store in the merchant information.

18. The system of claim 16 wherein a determining degree of similarity between a product category stored in the user profile and a product category stored in the merchant information comprises determining whether the product category stored in the user profile and the product category stored in the merchant information belong to a same parent product category.

19. The system of claim 16 wherein a determining degree of similarity between a product stored in the user profile and a product stored in the merchant information comprises determining whether other users who purchased the product stored in the merchant information have also purchased a product stored in the user profile.

20. The system of claim 14 wherein ranking the merchant information based on the correlation identified between the user profile and the merchant information further comprises identifying one or more events occurring within a predefined area and ranking stores, product categories, or products associated with the one or more events above other stores, product categories, or products present in the merchant information.
